(19) United States
(12) Patent Application Publication
(10) Pub. No.: US 2004/0160761 A1
(43) Pub. Date: Aug. 19, 2004

(54) Case for household appliance with water reservoir

(75) Inventors: Philippe Dumoux, Gemeaux (FR); Nicolas Pretre, Dijon (FR)

Correspondence Address: BROWDY AND NEIMARK, P.L.L.C., 624 NINTH STREET, NW, SUITE 300, WASHINGTON, DC, 20001-5303, US

(73) Assignee: SEB S.A., Ecully (FR)

(21) Appl. No.: 10/779,608

(22) Filed: Feb. 18, 2004

(30) Foreign Application Priority Data
Feb. 18, 2003 (FR) FR-03 02041

(51) Int. Cl. F02C 3/22

(52) U.S. Cl. 362/89

(57) ABSTRACT

A case for a household electric appliance, composed of a base containing a signal light and provided with a passage, a water reservoir disposed above the base, and a light conducting window mounted in the passage and disposed to be illuminated by the signal light. The window is fixed to the water reservoir.

### BACKGROUND OF THE INVENTION

The present invention relates to the general technical field of household electric appliances having a water reservoir secured to a case that contains electric equipment. The present invention concerns particularly, but not exclusively, steam cookers.

It is known in appliances of the type mentioned above to provide a water reservoir disposed upon a base containing electric equipment. Such appliances can be equipped with a signal light that indicates when the appliance is in operation. The base containing the electric equipment being opaque, a transparent or translucent window is installed in an opening of the base at a location opposite the light. Such a form of construction presents the drawback of requiring a number of assembly steps.

### BRIEF SUMMARY OF THE INVENTION

The present invention serves to simplify the assembly, and facilitate the use, of a case of the type described above.

More specifically, the present invention provides a case for a household electric appliance having a water reservoir disposed above a base containing a signal light, a transparent or translucent window being mounted in a passage provided in the base, the window being disposed to be illuminated by the signal light, wherein the window is fixed to the water reservoir. This arrangement permits assembly of the case to be simplified.

Advantageously, the water reservoir is made of a transparent or translucent plastic material. Such a material can easily be fabricated by molding, such as injection molding.

Also advantageously, the water reservoir has a bottom beneath which the signal light is mounted. The base can be a simple protective part closing the compartment of the appliance, the different electrical parts of the appliance being mounted under the bottom of the reservoir.

Also advantageously, the window is formed by a tongue that extends from the water reservoir, the tongue being prolonged on a lateral wall of the water reservoir by a facet, or pane, possibly thin, forming a water level indicator. This arrangement permits a water level to exist above the window that is illuminated by the signal light.

According to one form of construction, the facet is connected to the tongue by a transparent and/or translucent wall disposed above the signal light.

Advantageously, the tongue has an internal face provided with grooves. This arrangement permits a large surface area illuminated by the signal light to be obtained. This arrangement also permits an indication of the operation of the light to be provided in a clear manner.

Also advantageously, the facet has an outer face and an inner face having a polished surface. Such a surface state can, in particular, be obtained by polishing the corresponding surfaces of the mold used to fabricate the part forming the water reservoir. This practice facilitates reading of the water level.

Also advantageously, two upwardly extending ribs laterally delimit the facet on the internal face of the lateral wall. This facilitates illumination of the water level due to light reflection.

Also advantageously, the two upwardly extending ribs have a thickness that decreases from their bottom to their top, finally merging into the lateral wall. This further facilitates illumination of the water level.

According to an advantageous form of construction, the water reservoir has a filling device. Alternatively, the filling device can in particular be arranged in a juice recovery tank disposed on the water reservoir.

The utilization of a water level is particularly desirable when the user can refill the water reservoir without having to withdraw elements of the appliance disposed above the reservoir.

### BRIEF DESCRIPTION OF THE DRAWINGS

FIG. 1 is a partial view of a household electric appliance case according to the invention.

FIG. 2 is a partial view, from below, of the outer part of the water reservoir forming a part of the case shown in FIG. 1.

FIG. 3 is a partial view of the interior of the water reservoir shown in FIG. 2.

FIG. 4 is a partial view, from below, of the lower part of the water reservoir shown in FIGS. 2 and 3.

FIG. 5 is a cross-sectional detail view of a first alternative form of construction.

FIG. 6 is a cross-sectional detail view of a second alternative form of construction.

### DETAILED DESCRIPTION OF THE INVENTION

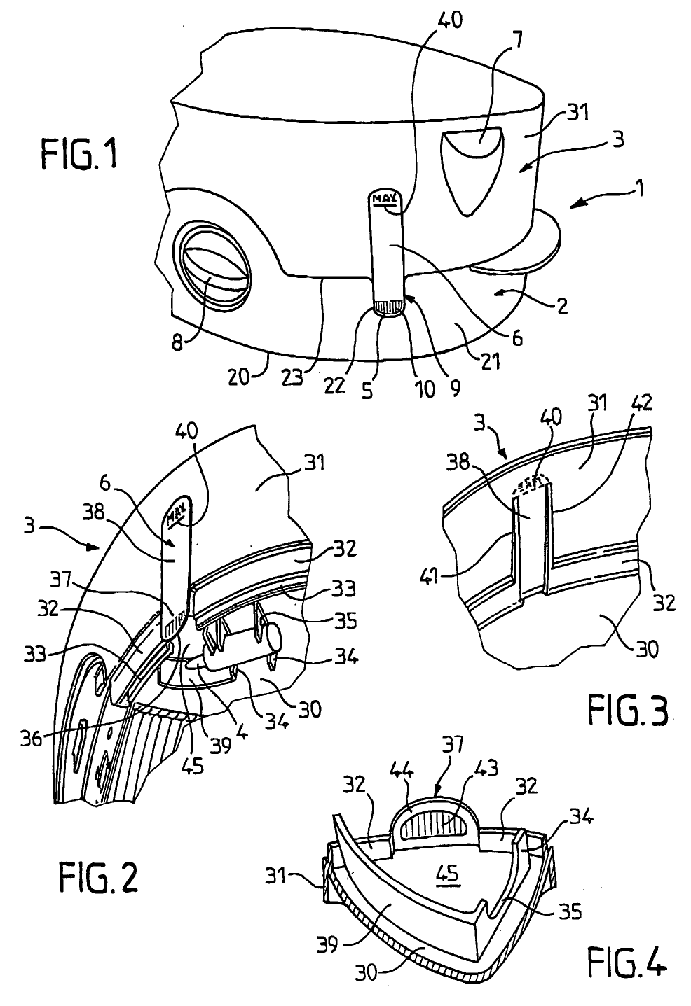

FIG. 1 shows a case 1 according to the invention having a base 2 above which is disposed a water reservoir 3. Case 1 is part of a household electric appliance such as a steam cooker. A cooking enclosure (not shown in the drawings) can be disposed on case 1 in a manner known in the art. Case 1 also has a luminous operation indicator 5, a water level indicator 6, a filling member 7 and a timer 8 that is used to place the appliance in operation.

Base 2 has a bottom 20 surmounted by an annular lateral wall 21. A recess, or indentation, 22 is provided in the upper edge of lateral wall 21. Base 2 is preferably made of a low cost opaque plastic material, such as polypropylene and is for example secured by screws to reservoir 3.

Reservoir 3 has a bottom 30, visible in FIGS. 2, 3 and 4, surmounted by an annular lateral wall 31. Filling member 7 is arranged on lateral wall 31, and lateral wall 31 has a lower portion 32 whose outer surface is inset from the outer surface of the remainder of wall 31 to permit nesting of water reservoir 3 in the upper part of lateral wall 21 of base 2. Portion 32 is prolonged downwardly by lower ribs 33 arranged beneath bottom 30. Reservoir 3 is advantageously made of a translucent plastic material, such as for example translucent polypropylene, or of a transparent plastic material such as for example polycarbonate.

Luminous operation indicator 5 includes a light source 4 mounted in case 1 under bottom 30 of reservoir 3. More particularly, bottom 30 has two downwardly extending support pieces 34 each formed to have a recess in which light source 4 can be housed and retained. A gap 36 is provided between lower ribs 33 to permit light from source 4 to reach a tongue 37 disposed at the periphery of the bottom 30 and beneath that bottom. Tongue 37 forms a prolongation of lateral wall 31. A space is provided between tongue 31 and lower ribs 33.

More particularly, tongue 37 is prolonged along the outer face of annular lateral wall 31 by a facet, or pane, 38 constituting water level indicator 6. The thickness of lateral wall 31 is slightly smaller at the level of facet 38. A rib 39 arranged under bottom 30 provides a surface that reflects light from source 4 toward gap 36 and tongue 37. A maximum water level mark 40 is placed near the top of facet 38.

The inner face of lateral wall 31 is smooth in order to limit the adherence of scale on that wall. The outer face of lateral wall 31 need not be polished, with the exception of facet 38. Facet 38 has an outer face and an inner face that are both given a polished state, in order to facilitate reading of the water level.

As shown in FIG. 3, two upwardly extending ribs 41,42 are provided on the inner face of lateral wall 31. These ribs 41,42 laterally delimit facet 38 and have a thickness that decreases progressively from their lower end to their upper end, merging at the upper end into lateral wall 31. Ribs 41,42 act to facilitate the guiding of light along facet 38.

FIG. 4 shows the inner surface of tongue 37 provided with vertical grooves 43 that allow a larger surface area to be illuminated by light source 4 in order to form in a clearly observable manner the operating light indicator 5 (shown in FIG. 1). Grooves 43 are surrounded by a peripheral rib 44.

Tongue 37 is housed in the recess 22 forming a passage 9 in base 2. Tongue 37 forms a window 10 that is fixed to reservoir 3 and extends into passage 9 formed in base 2 when reservoir 3 is installed on base 2. Tongue 37 thus eliminates the need for the separate assembly of a supplementary part of base 2. Window 10 is transparent or translucent, depending on the nature of the material selected. In addition, facet 38, which is an extension of tongue 37, permits the creation of the water level indicator 6 that makes use of the light provided by source 4. A part 45 of bottom 30 disposed between rib 39 and tongue 37 is illuminated by light source 4, which permits illumination of the water surface disposed in reservoir 3.

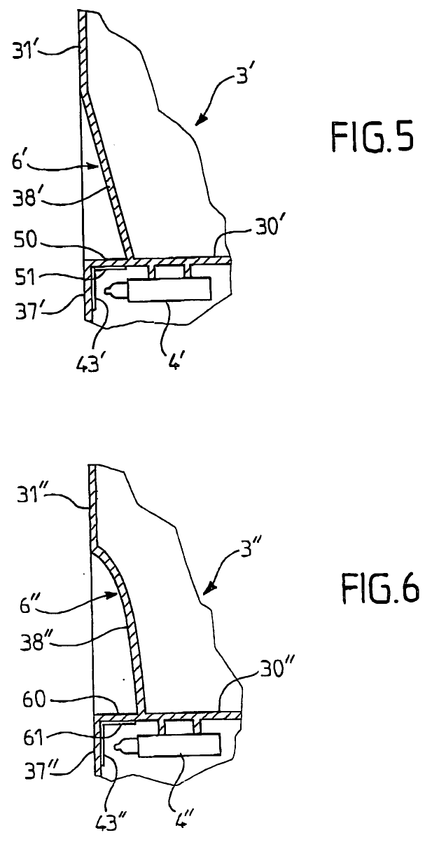

FIG. 5 shows a first alternative form of construction in which water reservoir 3′ has a water level indicator 6′ formed by a facet 38′ connected to tongue 37′ by a transparent and/or translucent wall 50 disposed above light source 4′. Tongue 37′ is provided with grooves 43′. Wall 50 can equally have grooves disposed, for example, on its inner, or lower, face. Wall 50 preferably has a polished surface state and constitutes a prolongation of bottom 30′. The upper end of facet 38′ is joined to lateral wall 31′. Light source 4′ illuminates the outer face of facet 38′ through wall 50′.

By way of example, and as shown in FIG. 5, facet 38′ may be flat and inclined to the vertical.

FIG. 6 shows a second alternative form of construction in which water reservoir 3″ has a water level indicator 6″ formed by a facet 38″ joined to tongue 37″ by a transparent and/or translucent wall 60 disposed above light source 4″. Tongue 37″ is provided with grooves 43″. Wall 60 preferably has a polished surface state and can equally be provided with grooves 61 disposed, for example, on its inner, or lower, face. Wall 60 constitutes a prolongation of bottom 30″. The upper end of facet 38″ is connected to lateral wall 31″. Light source 4″ illuminates the outer face of facet 38″ through wall 60.

By way of example, and as shown in FIG. 6, facet 38″ is curved and has a concave outer face.

According to a complementary variation of the above described forms of construction, tongue 37′,37″ can be replaced by wall 50,60. In other words, tongue 37′,37″ is not necessarily located in the plane of lateral face 31′,31″.

According to another complementary variation, filling device 7 is not necessarily formed in lateral wall 31 of reservoir 3, but can for example be arranged in a receptacle for recovering juices disposed on water reservoir 3.

According to yet another complementary variant, water reservoir 3,3′,3″ is not necessarily made entirely of transparent or translucent plastic. In particular, two-component injection molding can be used to form tongue 37,37′,37″ and facet 38,38′,38″ of transparent or translucent plastic material, while the remainder of the reservoir is made of an opaque plastic material. Bottom 30,30′,30″ is not necessarily entirely transparent or translucent. In particular, only part 45 of bottom 30, wall 50, or wall 60 need be made of transparent or translucent plastic.

By way of a further complementary variation, grooves 43,43′,43″,51 and 61 could be formed in an outer, or upper, face of the associated part.

This application relates to subject matter disclosed in French Application number FR 03 02041, filed on Feb. 18, 2003, the disclosure of which is incorporated herein by reference.

While the description above refers to particular embodiments of the present invention, it will be understood that many modifications may be made without departing from the spirit thereof. The accompanying claims are intended to cover such modifications as would fall within the true scope and spirit of the present invention.

The presently disclosed embodiments are therefore to be considered in all respects as illustrative and not restrictive, the scope of the invention being indicated by the appended claims, rather than the foregoing description, and all changes which come within the meaning and range of equivalency of the claims are therefore intended to be embraced therein.

What is claimed is:

1. A case for a household electric appliance, said case comprising: a base containing a signal light and provided with a passage; a water reservoir disposed above said base; and a light conducting window mounted in said passage and disposed to be illuminated by said signal light, wherein said window is fixed to said water reservoir.

2. The case of claim 1, wherein said water reservoir is made of a transparent or translucent plastic material.

3. The case of claim 2, wherein said water reservoir has a bottom beneath which said signal light is mounted.

4. The case of claim 1, wherein said water reservoir has a bottom beneath which said signal light is mounted.

5. The case of claim 4, wherein said window is composed of a tongue that extends from said water reservoir, and said case further comprises a pane of light conducting material disposed in a lateral wall of said reservoir, said pane forming a water level indicator.

6. The case of claim 5, further comprising a light conducting wall disposed above said signal light and connecting said pane to said tongue.

7. The case of claim 5 wherein said tongue has a surface provided with grooves.

8. The case of claim 5 wherein said pane has at least one polished surface.

9. The case of claim 5 wherein said pane has two upwardly extending ribs laterally delimiting said pane and located at an internal face of said lateral wall of said reservoir.

10. The case of claim 9 wherein each of said two upwardly extending ribs has a thickness that decreases from the bottom to the top, and each of said two upwardly extending ribs merges at the top of said pane into said lateral wall.

11. The case of claim 3, wherein said window is composed of a tongue that extends from said water reservoir, and said case further comprises a pane of light conducting material disposed in a lateral wall of said reservoir, said pane forming a water level indicator.

12. The case of claim 2, wherein said window is composed of a tongue that extends from said water reservoir, and said case further comprises a pane of light conducting material disposed in a lateral wall of said reservoir, said pane forming a water level indicator.

13. The case of claim 1, wherein said window is composed of a tongue that extends from said water reservoir, and said case further comprises a pane of light conducting material disposed in a lateral wall of said reservoir, said pane forming a water level indicator.

14. The case of claim 13, further comprising a light conducting wall disposed above said signal light and connecting said pane to said tongue.

15. The case of claim 13 wherein said tongue has a surface provided with grooves.

16. The case of claim 13 wherein said pane has at least one polished surface.

17. The case of claim 13 wherein said pane has two upwardly extending ribs laterally delimiting said pane and located at an internal face of said lateral wall of said reservoir.

18. The case of claim 17 wherein each of said two upwardly extending ribs has a thickness that decreases from the bottom to the top, and each of said two upwardly extending ribs merges at the top of said pane into said lateral wall.

19. The case of claim 1, further comprising a filling device associated with said reservoir.
